(19) United States
(12) Patent Application Publication
(10) Pub. No.: US 2009/0275345 A1
(43) Pub. Date: Nov. 5, 2009

(54) APPARATUS AND METHOD FOR PROVIDING LOCATION INFORMATION AND APPARATUS FOR SUPPORTING LOCATION BASED SERVICE AND METHOD FOR USING LOCATION BASED SERVICE

(75) Inventors: Ji-sang KIM, Yongin-si (KR); Hyun-seok Choi, Seoul (KR); Young-keun Kim, Seoul (KR); Han-sung Kim, Seongnam-si (KR); Hyun-chang Shin, Gunpo-si (KR); Jin-min Kim, Seoul (KR); Ji-woon Jung, Seoul (KR)

Correspondence Address: STEIN MCEWEN, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/274,510

(22) Filed: Nov. 20, 2008

(30) Foreign Application Priority Data
May 1, 2008 (KR) 2008-41051

(51) Int. Cl. H04W 4/02

(52) U.S. Cl. 455/456.1

(57) ABSTRACT

A location information providing apparatus to provide a location thereof, the location information providing apparatus including: a storage unit to store location information regarding the location of the location information providing apparatus; and a transmitter to transmit the location information. Therefore, precise location information can be provided. In addition, a location-based service can be performed in a simple way because there is no need to consider a handoff depending on a movement of a location-based service supporting apparatus, and a service area can be expanded abroad because a wired network is not required. Also, various opportunities using the location-based service can be realized.

### CROSS-REFERENCE TO RELATED APPLICATION

This application claims the benefit of Korean Patent Application No. 2008-41051, filed on May 1, 2008 in the Korean Intellectual Property Office, the disclosure of which is incorporated herein in its entirety by reference.

### BACKGROUND OF THE INVENTION

1. Field of the Invention

Aspects of the present invention relate to an apparatus and method of providing location information, an apparatus to support a location-based service, and a method of using the location-based service, and more particularly, to an apparatus and method of providing exact location information, and an apparatus to support the location-based service using the exact location information and a method of using the location-based service.

2. Description of the Related Art

Location-based services are service systems to provide users with information on various services based on location information obtained through a mobile communication network or a global positioning system (GPS). Location-based services provide users with various kinds of information dependant on the location (for example, road directions, public safety information, and location-based information) by including a chip in a mobile phone communicating with base stations or the GPS. That is, location-based services provide various services based on the location information obtained through wired and/or wireless communication networks.

The location-based services can be classified into a cell type that uses base stations of a mobile communication network, and a GPS type using GPS. The cell type location-based service has been developed and distributed since 2000. It is difficult to find a precise location using the cell type location-based service because a locating error range can sometimes be in the order of a few kilometers. However, the cell type location-based service has the advantage that a position inside a building or underground can be located by using repeaters. In the GPS type location-based service, the chip attached in the mobile phone reads location information transmitted from satellites and notifies a base station of the location information. The GPS type location-based service is distributed next to the cell type, and a precise locating can be performed because the error range using the GPS type is in the order of about a few hundreds meters. However, the GPS type location-based service cannot be used in high-story buildings or indoors, which reflect or refract signals, due to the characteristics of satellite signals.

Using the location-based service, locations of people or vehicles can be found and traced. Furthermore, when a user is in a dangerous environment or situation (for example, in places such as mountains or deserts), the user can contact rescue services by pushing an emergency button of the mobile phone. In addition, a service to provide weather information regarding the region where the user of the mobile phone is in, an alarm service for subscribers in a certain area, a traffic information service to find shortcuts, a life information service to find close department stores, hospitals, theaters, or restaurants, and a telematics service to provide information during moving can be provided by the location-based service.

The location-based services market is being commercialized in various aspects. Accordingly, a technology to determine a location indoors or places to which GPS signals cannot reach is desired and, accordingly, indoor location determination technologies using various methods are being developed and commercialized. In addition, various kinds of wireless communication technologies are being developed rapidly. In particular, services such as mobile communication, wireless local area network (WLAN), digital broadcasting, and satellite communication are rapidly increasing. Currently, models of location-based services, in which various indoor location determination technologies and communication methods are combined, have been suggested. Also, suggested location-based services are mostly based on wired network infrastructure and access point (AP).

Examples of the location determination technology in “dead” spaces (such as indoors) include a location determination technology using ground wave base stations, a location determination technology based on TV field sync signals, a location determination technology based on DTV TxID signals, a location determination technology based on the wireless communication, and an indoor location determination technology based on near field communication. The location determination technology using the ground wave base station uses ground wave base stations in order to reduce an error range of location determination using mobile communication base stations. The location determination technology based on the TV field sync signal is similar to the technology using the ground wave, however, uses low frequency signals. In the location determination technology based on the DTV TxID signal, sequences for TxID are made to have a low amplitude value and a watermark is inserted into the sequence. Then, a receiving end recovers the sequence to apply the sequence in location determination. The location determination technology based on mobile communication uses mobile communication devices (such as the mobile phone), and has an error range of about 100-1000 meters in urban areas. The indoor location determination technology based on the near field communication may use infrared ray signals, ultrasonic wave signals, radio frequency identification (RFID), or ultra wide band (UWB), for example.

However, the above location determination technologies have low accuracy in the determination of a location, and have a limitation in providing a precise location (such as an altitude or a cell) in a building.

### SUMMARY OF THE INVENTION

Aspects of the present invention provide an apparatus and method of providing location information, that transmits precise location information on a story or a cell unit of a building, and a system and method of providing location-based services using the location information.

According to an aspect of the present invention, there is provided a location information providing apparatus to provide precise location information thereof, the apparatus including: a storage unit to store location information regarding the precise location of the location information providing apparatus; and a transmitter to transmit the location information.

The transmitter may transmit the location information regularly according to a predetermined transmitting period.

The transmitter may broadcast the location information.

The location information may include a latitude, a longitude, and an altitude of the precise location of the location information providing apparatus.

The location information may further include location characteristic information corresponding to the latitude, the longitude, and the altitude of the location.

The location information may include location characteristic information corresponding to the location of the location information providing apparatus.

The location information providing apparatus may be installed in a vehicle; and the location information may include a transportation type of the vehicle and/or identification information of the vehicle.

The location information providing apparatus may be installed in a building; and the location information may include a floor number of the location information providing apparatus in the building.

The location information providing apparatus may further include: a receiver to receive updated location information; and a controller to store the received updated location information in the storage unit.

The transmitter may transmit the location information through a wireless personal area network (WPAN).

The location information providing apparatus may further include: a power unit to supply electric power to the location information providing apparatus from an external electric power unit.

The storage unit may store additional information, different from the location information, corresponding to the location of the location information providing apparatus.

According to another aspect of the present invention, there is provided a location-based service supporting apparatus receiving location information from a location information providing apparatus, the location-based service supporting apparatus including: a receiver to receive location information including an altitude of a location of the location information providing apparatus, transmitted from the location information providing apparatus; and an output unit to output the received location information.

The output unit may output the received location information in an audio format.

The location-based service supporting apparatus may further include: a controller to execute a location-based service based on the received location information.

The location-based service supporting apparatus may further include a storage unit to store a location-based service application, wherein the controller executes the location-based service application according to the received location information.

The receiver may receive additional information, different from the location information, corresponding to the location of the location information providing apparatus.

the location information may include location characteristic information corresponding to the location of the location information providing apparatus.

The location information may be broadcast from the location information providing apparatus.

The location-based service supporting apparatus may further include: a transmitter to request the location-based service based on the received location information from a web or a server through a communication network, wherein the controller executes the location-based service transmitted from the web or the server.

According to another aspect of the present invention, there is provided a method of providing location information in a location information providing apparatus, the method including: storing information regarding a precise location of the location information providing apparatus; and transmitting the location information.

According to yet another aspect of the present invention, there is provided a method of using a location-based service in a location-based service supporting apparatus that receives location information from a location information providing apparatus, the method including: receiving location information including an altitude of a location of the location information providing apparatus, from the location information providing apparatus; and outputting the received location information.

According to still another aspect of the present invention, there is provided a method of using a location-based service in a location-based service supporting apparatus that receives location information from a location information providing apparatus, the method including: receiving location information including an altitude of a location of the location information providing apparatus, from the location information providing apparatus; and executing the location-based service according to the received location information.

According to another aspect of the present invention, there is provided a system to execute a location-based service, the system including: a location information providing apparatus to provide a precise location thereof, the location information providing apparatus including: a storage unit to store location information regarding the precise location of the location information providing apparatus, and a transmitter to transmit the location information; and a location-based service supporting apparatus including: a receiver to receive the location information, transmitted from the location information providing apparatus; and a controller to execute the location-based service based on the received location information.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram showing a location-based service system according to an embodiment of the present invention;

FIG. 2 is a flowchart illustrating a method of providing location information according to an embodiment of the present invention;

FIG. 3 is a flowchart illustrating a method of using location-based service in an apparatus to support the location-based service according to an embodiment of the present invention; and

FIG. 4 is a diagram showing an example of using the location-based service according to the embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

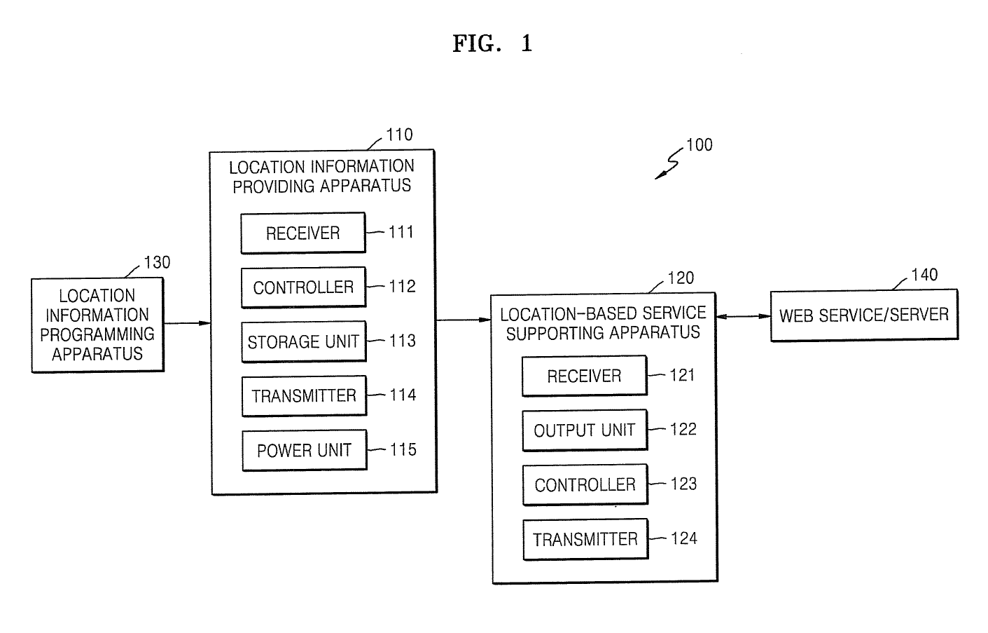

FIG. 1 is a block diagram showing a location-based service system 100 according to an embodiment of the present invention. Referring to FIG. 1, the location-based service system 100 includes a location information providing apparatus 110, a location-based service supporting apparatus 120, a location information programming apparatus 130, and a web-service or a server 140. The location information providing apparatus 110 includes a receiver 111, a controller 112, a storage unit 113, a transmitter 114, and a power unit 115. The location-based service supporting apparatus 120 includes a receiver 121, an output unit 122, a controller 123, and a transmitter 124.

The location information providing apparatus 110 transmits information about a location of the location information providing apparatus 110 to the location-based service supporting apparatus 120. The location information providing apparatus 110 is a fixed device that is installed on a fixed location (such as a building). The location information is the exact information including a latitude, a longitude, and an altitude of the location of the location information providing apparatus 110. For example, when the location information providing apparatus 110 is installed in Galleria Department Store, Apgujeong-dong, Kangnam-gu, Seoul, Korea, the location information is “37°31′41.99″N, 127°02′22.73″E, 15 meter.” The location information may show the information of the location in an order of latitude, longitude, and altitude. In addition, when the location information providing apparatus 110 is attached to exit No. 7, Seoul National University station of Seoul subway line No. 2, the location information is “37°28′52.35″N, 126°57′12.02″E, −3 meter.” However, when the location information is represented as above, the user using the location information may not be able to intuitively recognize the location. Therefore, the location information of the two examples provided above may be represented as location characteristic information, such as “third floor, Galleria Department Store, Apgujeong-dong, Kangnam-gu, Seoul, Korea and “exit No. 7, Seoul National University station, Seoul subway line No. 2,” respectively, corresponding to the detailed latitude, longitude, and altitude information. The location information can be stored in the location information providing apparatus 110 in advance, or the location information providing apparatus 110 can change the latitude, longitude, and altitude information to the above formation. As described above, the location information according to aspects of the present invention is exact and includes detailed information that can represent the location of the space defined by stories and cells, as well as the entire building. In addition, the location information providing apparatus 110 can provide additional information. The additional information is provided based on the location of the location information providing apparatus 110 is installed. For example, when the location information providing apparatus 110 is installed on “third floor, Galleria Department Store, Apgujeong-dong, Kangnam-gu, Seoul, Korea,” the additional information may include information about stores, prices of products, sale information, and advertisements. In addition, when the location information providing apparatus 110 is attached to “exit No. 7, Seoul National University station, Seoul subway line No. 2,” the additional information can include a subway map, expected travel times to other stations, buildings around exit No. 7, and street information. However, it is understood that the additional information is not limited to the above examples.

The receiver 111 receives updated location information and/or additional information from the location information programming apparatus 130. The location information and/or the additional information may be received, and, stored in the storage unit 113, when the location information providing apparatus 110 is attached to a certain location. However, it is understood that aspects of the present invention are not limited thereto. For example, the location information can be set by the system provider in advance. In addition, when the location information and/or the additional information is updated, the receiver 111 receives the updated location information and/or the additional information and stores the received information in the storage unit 113. The receiver 111 receives the location information and/or the additional information from the location information programming apparatus 130 through a wired connection (such as universal serial bus) or a wireless connection (such as Bluetooth). However, the connection type is not limited to the above examples, and the location information providing apparatus 110 can communicate with the location information programming apparatus 130 through various wired and/or wireless connections.

The storage unit 113 stores the received location information and the additional information. The storage unit 113 may be a volatile memory (such as RAM) or a non-volatile memory (such as ROM, flash memory, or a hard disk drive). For example, portable storage media, smart media, a memory stick, a CF card, an XD card, an SD card, an SDHC card, and a multimedia card (MMC) can be used as the storage unit 113.

The transmitter 114 transmits the location information and/or the additional information stored in the storage unit 113 to the location-based service supporting apparatus 120. The transmitter 114 may include a simplex or duplex near field communication modem in order to communicate with the location-based service supporting apparatus 120. In the present embodiment, the transmitter 114 includes the simplex near field communication modem. That is, the transmitter 114 may communicate with the location-based service supporting apparatus 120 using a broadcasting method. In the broadcasting communication, a source and destinations are in a one-to-all relation. That is, one source exists, and the other hosts become the destinations. The communication may be performed through a wireless personal area network (WPAN). The transmitter 114 may transmit or broadcast the location information and/or the additional information regularly according to a predetermined transmitting period. The transmitting (or broadcasting) period can be set by the manufacturer of the apparatus or a user thereof. However, the transmitter 114 may also transmit the location information and/or the additional information when a request is received from the location-based service supporting apparatus 120.

The power unit 115 receives electric power from an external electric power line to supply the electric power to the location information providing apparatus 110. In the present embodiment of the present invention, the power unit 115 receives an alternating current (AC) power from the external electric power line. The power unit 115 may include a device that converts the AC power to a direct current (DC) power. However, it is understood that the power unit 115 is not limited to the above example, and the power unit 115 may include a small size battery to supply the electric power locally.

The controller 112 controls the components in the location information providing apparatus 110. The controller 112 stores the location information and/or the additional information received by the receiver 111 in the storage unit 113, and extracts the location information and/or the additional information stored in the storage unit 111 to transmit the information to the transmitter 114.

The location information providing apparatus 110 is not limited to the fixed space (such as a building), but also can be installed on a moving space. That is, the location information providing apparatus 110 can be attached to transportation vehicles (such as buses or subways). In this case, the location information can include the kind of the transportation or identification information of the transportation. For example, when the location information providing apparatus 110 is attached to a subway train, the location information can be “cells 3-4, train No. 1200, subway line No. 2.” The additional information can include information regarding the subway line, information regarding the stations, etc. When the location information providing apparatus 110 is attached to the transportation vehicle, the location-based service supporting apparatus 120 can receive location information of other stations from other location information providing apparatuses 110 attached to the other stations.

The location-based service supporting apparatus 120 may be a mobile apparatus, though it is understood that aspects of the present invention are not limited thereto. Any device that can receive the location information and/or the additional information from the location information providing apparatus 110 and output the received information can be used as the location-based service supporting apparatus 120. The receiver 121 receives the location information and/or the additional information sent or broadcast from the location information providing apparatus 110. The output unit 122 outputs the received location information and/or the additional information through a display (not shown). Otherwise, the output unit 122 can output the location information and/or the additional information as audio through a sound output apparatus such as a speaker (not shown). The location-based service supporting apparatus 120 may include an application (such as software) by which a location-based service that is based on the location information and/or the additional information can be provided. In this case, the controller 123 can operate the location-based service application based on the received location information and/or the additional information. If the location-based service supporting apparatus 120 does not include the application, the transmitter 124 may request the location-based service application of a web or a server 140 that supports the location-based service through a communication network. Accordingly, the controller 123 operates the location-based service application transmitted from the web or the server 140.

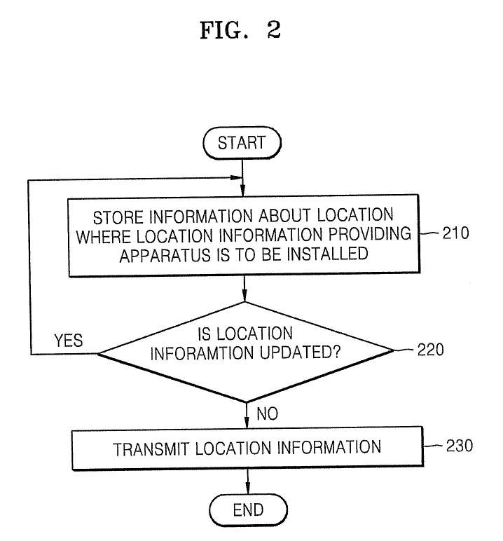

FIG. 2 is a flowchart illustrating a method of providing the location information according to another embodiment of the present invention. Referring to FIG. 2, the location information (for example, including the latitude, longitude, and altitude) of where a location information providing apparatus is installed or is to be installed is stored in the apparatus in operation S210. The location information represents an exact address of the location of the location information providing apparatus, and may also represents the floor where the location information providing apparatus is installed in a building. For example, when the location information providing apparatus is installed in Galleria Department Store, Apgujeong-dong, Kangnam-gu, Seoul, Korea, the location information is “37°31′41.99″N, 127°02′22.73″E, 15 meter.” Here, “15 meter” is the altitude of the apparatus. When it is assumed that the height of the third floor is 15 meters, the location information is “third floor, Galleria Department Store, Apgujeong-dong, Kangnam-gu, Seoul, Korea.” However, when the location information is represented as above (i.e., latitude, longitude, and altitude), the user using the location information may not be able to intuitively recognize the location. Therefore, the location information can be represented as “third floor, Galleria Department Store, Apgujeong-dong, Kangnam-gu, Seoul, Korea” corresponding to the detailed latitude, longitude, and altitude information. The location information can be stored in the location information providing apparatus in advance, or the location information providing apparatus can change the information including latitude, longitude, and altitude to the above form. In addition, the location information providing apparatus can include the additional information. The additional information is provided based on the location of the location information providing apparatus. For example, when the location information providing apparatus is installed on “third floor, Galleria Department Store, Apgujeong-dong, Kangnam-gu, Seoul, Korea,” the additional information can include the information about stores, prices of products, sale information, and advertisements. In addition, the location information providing apparatus is not provided in a space (such as a building), but can also be attached to a moving space. That is, the location information providing apparatus can be attached to a transportation vehicle (for example, buses or subways). In this case, the location information can include the kind of the transportation or identification information of the transportation vehicle. For example, when the location information providing apparatus is attached to a subway train, the location information can be “cells 3-4, train No. 1200, subway line No. 2.” The additional information can include information regarding the subway line, and information regarding the stations.

It is determined whether the location information and/or the additional information is updated in operation S220. When the information is updated, operation S210 is performed. In contrast, when the information is not updated, operation S230 is performed. Specifically, when the information is updated, the updated location information and/or the updated additional information that is transmitted from the location information programming apparatus is stored in the location information providing apparatus. The location information providing apparatus receives the location information and/or the additional information from the location information programming apparatus through a wired connection (such as Universal Serial Bus or a wireless connection such as Bluetooth). However, it is understood that aspects of the present invention are not limited thereto, and the connection between the location information providing apparatus and the location information programming apparatus may be a wired and/or a wireless connection.

The location information providing apparatus transmits the location information and/or the additional information to the location-based service supporting apparatus in operation S230. The location information may be broadcast by the location information providing apparatus. Furthermore, the location information providing apparatus may include a simplex or duplex near field communication modem in order to communicate with the location-based service supporting apparatus. In the present embodiment, the location information is transmitted using the simplex near field communication modem. That is, the location information providing apparatus may communicate with the location-based service supporting apparatus using a broadcasting method. Also, the communication between the location information providing apparatus and the location-based service supporting apparatus may be performed through WPAN. The location information providing apparatus may transmit the location information or the additional information regularly according to a predetermined transmitting period. The transmitting period can be set by a manufacturer or a user of the apparatus. However, the location information providing apparatus may also transmit the location information and/or the additional information when a request is received from the location-based service supporting apparatus.

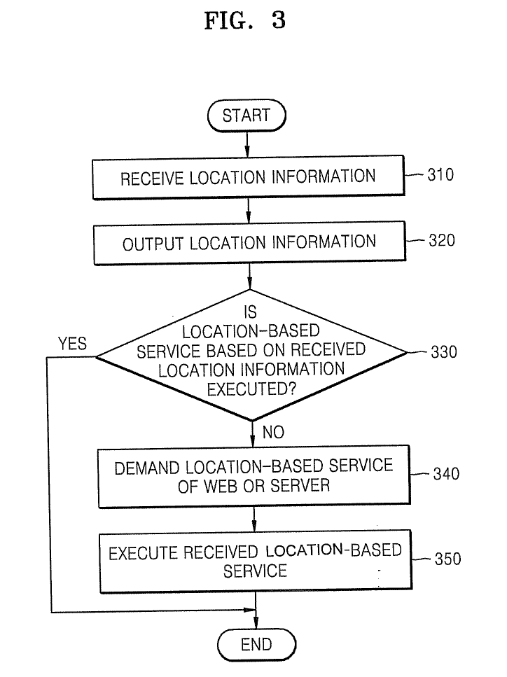

FIG. 3 is a flowchart illustrating a method of using the location-based service in the location-based service supporting apparatus according to an embodiment of the present invention. Referring to FIG. 3, the location-based service supporting apparatus receives the location information and/or the additional information transmitted from the location information providing apparatus in operation S310. The location-based service supporting apparatus may communicate with the location information providing apparatus using a broadcasting method, and may communicate with the location information providing apparatus through a WPAN.

The location-based service supporting apparatus outputs the received location information and/or the additional information in operation S320. The information may be output through a display and/or a speaker.

It is determined whether the location-based service can be performed based on the location information and/or the additional information received by the location-based service supporting apparatus in operation S330. When the location-based service can be performed (for example, when the location-based service supporting apparatus stores an application such as software that can provide the location-based service based on the location information and/or the additional information), the location-based service application is executed. When the location-based service application cannot be executed, the location-based service supporting apparatus requests a location-based service application of the web or a server storing the location-based service application in operation S340. Accordingly, the location-based service application transmitted from the web or the server is executed in operation S350.

As an example of the above location-based service using method, a case in which a user of the location-based service supporting apparatus uses the location-based service from a departure to a destination will be described. The user of the location-based service supporting apparatus receives information of the current location from the location information providing apparatus (for example, the current location is “sixth floor, Koryo building, Seocho-dong, Seocho-gu, Seoul, Korea”). Next, when the user inputs the destination (for example, “Samsung Electronics, Suwon-city, Kyunggi-do, Korea”), the location-based service supporting apparatus provides the location-based service showing a travelling path (for example, taking subway line No. 2 at Seoul National University of Education Station, getting off the subway at Kangnam Station and exiting Kangnam Station through exit No. 3, and taking bus No. 5430 to Samsung Electronics Station in Suwon). Otherwise, the user can receive the travelling path from the web or the server supporting the location-based service.

As another example, when the user of the location-based service supporting apparatus is in a department store, the user can use the location information and/or the additional information regarding the department store. In this case, the location-based service supporting apparatus searches life logs of the user to analyze the user's taste in shopping, and provides product information (for example, brand, location, and price of the product) depending on the taste. In addition, the product information can be transmitted from the web or the server.

As another example, when the user of the location-based service supporting apparatus is requested to inspect a meter from an infrastructure provider (such as an electric power company), the user can provide the electric power company with the inspection data and the location information transmitted from the location information providing apparatus. In this case, the infrastructure provider can handle the inspection data according to the address based on the location information.

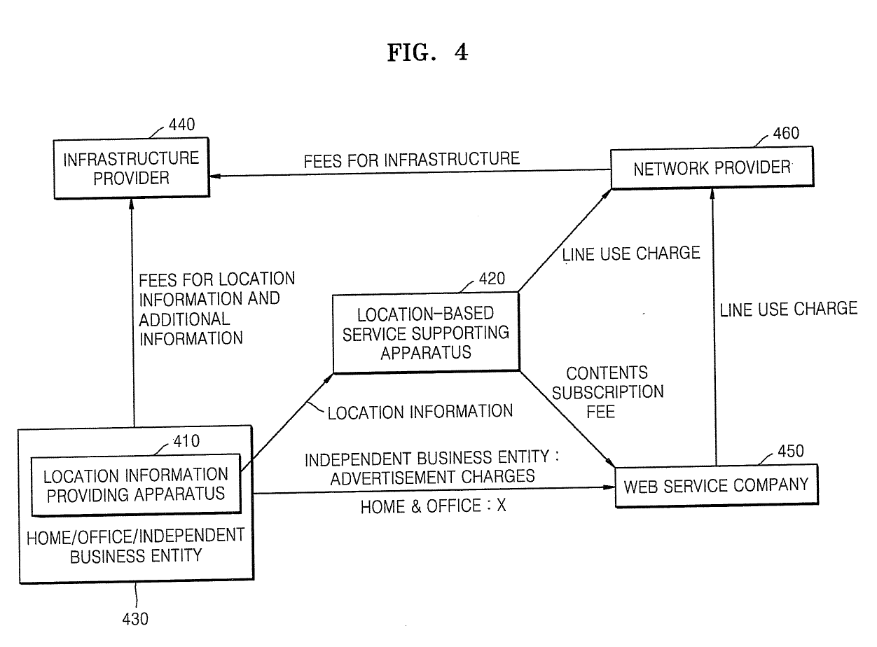

FIG. 4 shows an example of using the location-based service according to the embodiment of the present invention. Referring to FIG. 4, a location information providing apparatus 410 is installed in a building, in which a home, office, and or independent business entity 430 is located. If the location information providing apparatus 410 is installed or provided by an infrastructure provider 440, the infrastructure provider 440 collects fees for location information and/or additional information from an owner of the building, in which the home, office, and/or independent business entity 430 is located. If a business proprietor of the location-based service supporting apparatus 420 runs a location-based service business, the business proprietor may sell the location information providing apparatuses to owners of the buildings. The location-based service supporting apparatus 420 receiving the location information from the location information providing apparatus 410 can use the location-based service by paying a line use charge to a network provider 460 (for example, SK Telecom Co.) or by paying a content subscription fee to a web-service company 450 (for example, google.com). In addition, the web-service company 450 pays the network provider 460 the line use charge, and the network provider 460 pays fees for infrastructure to the infrastructure provider 440.

Aspects of the present invention can also be embodied as computer-readable codes on a computer-readable recording medium. The computer-readable recording medium is any data storage device that can store data that can be thereafter read by a computer system. Examples of the computer-readable recording medium include read-only memory (ROM), random-access memory (RAM), CD-ROMs, magnetic tapes, floppy disks, optical data storage devices. The-computer readable recording medium can also be distributed over network-coupled computer systems so that the computer readable code is stored and executed in a distributed fashion. Also, operational programs, codes, and code segments for accomplishing aspects of the present invention can be easily construed by programmers skilled in the art to which aspects of the present invention pertain. Aspects of the present invention may also be realized as a data signal embodied in a carrier wave and comprising a program readable by a computer and transmittable over the Internet.

According to aspects of the present invention, precise location information including an altitude of a place on which a location information providing apparatus is installed can be provided. In addition, the location-based service can be performed in a simple way because a handoff depending on the movement of a location-based service supporting apparatus is not performed, and a service area can be expanded abroad because a wired network is not required.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A location information providing apparatus to provide a location thereof, the location information providing apparatus comprising:
a storage unit to store location information regarding the location of the location information providing apparatus; and
a transmitter to transmit the location information.

2. The location information providing apparatus as claimed in claim 1, wherein the transmitter transmits the location information regularly according to a predetermined transmitting period.

3. The location information providing apparatus as claimed in claim 1, wherein the location information includes a latitude, a longitude, and an altitude of the location of the location information providing apparatus.

4. The location information providing apparatus as claimed in claim 1, wherein:
the location information providing apparatus is installed in a vehicle; and
the location information includes a transportation type of the vehicle and/or identification information of the vehicle.

5. The location information providing apparatus as claimed in claim 1, further comprising:
a receiver to receive updated location information; and
a controller to store the received updated location information in the storage unit.

6. The location information providing apparatus as claimed in claim 1, wherein the transmitter transmits the location information through a wireless personal area network (WPAN).

7. The location information providing apparatus as claimed in claim 1, further comprising:
a power unit to supply electric power to the location information providing apparatus from an external electric power unit.

8. A location-based service supporting apparatus to receive location information from a location information providing apparatus, the location-based service supporting apparatus comprising:
a receiver to receive location information including an altitude of a location of the location information providing apparatus, transmitted from the location information providing apparatus; and
an output unit to output the received location information.

9. The location-based service supporting apparatus of claim 8, wherein the output unit outputs the received location information in an audio format.

10. The location-based service supporting apparatus of claim 8, further comprising:
a controller to execute a location-based service based on the received location information.

11. The location-based service supporting apparatus of claim 10, further comprising:
a transmitter to request the location-based service based on the received location information from a web or a server through a communication network,
wherein the controller executes the location-based service transmitted from the web or the server.

12. A method of providing location information in a location information providing apparatus, the method comprising:
storing location information regarding a location of the location information providing apparatus; and
transmitting the location information.

13. The method as claimed in claim 12, wherein the transmitting of the location information comprises:
transmitting the location information regularly according to a predetermined transmitting period.

14. The method as claimed in claim 12, wherein the location information includes a latitude, a longitude, and an altitude of the location of the location information providing apparatus.

15. The method as claimed in claim 12, wherein:
the location information providing apparatus is installed in a vehicle; and
the location information includes a transportation type of the vehicle and/or identification information of the vehicle.

16. The method as claimed in claim 12, wherein the transmitting of the location information comprises:
transmitting the location information through a wireless personal area network (WPAN).

17. The method as claimed in claim 12, further comprising:
receiving and storing updated location information.

18. A method of using a location-based service in a location-based service supporting apparatus that receives location information from a location information providing apparatus, the method comprising:
receiving location information including an altitude of a location of the location information providing apparatus, from the location information providing apparatus; and
outputting the received location information.

19. The method as claimed in claim 18, further comprising:
executing the location-based service based on the received location information.

20. The method as claimed in claim 19, further comprising:
requesting the location-based service based on the received location information from a web or a server through a communication network.
